(19) United States
(12) Patent Application Publication
(10) Pub. No.: US 2016/0148211 A1
(43) Pub. Date: May 26, 2016

(54) Identity Protection

(71) Applicant: BLUE SUN TECHNOLOGIES, INC., Malibu, CA (US)

(72) Inventors: Jeffrey M. Stibel, Malibu, CA (US); Aaron B. Stibel, Hidden Hills, CA (US); Moujan Kazerani, Santa Monica, CA (US); Judith Gentile Hackett, Santa Monica, CA (US)

(21) Appl. No.: 14/947,974

(22) Filed: Nov. 20, 2015

Related U.S. Application Data
(60) Provisional application No. 62/082,377, filed on Nov. 20, 2014.

(51) Int. Cl. G06Q 20/40; H04L 29/06; H04L 29/08

(52) U.S. Cl. CPC G06Q 20/4014; H04L 67/306; H04L 63/1433; H04L 63/10; H04L 63/12

(57) ABSTRACT

Some embodiments provide holistic and comprehensive identity protection solutions. The solutions protect user identity by screening the information trail that a user leaves behind online in order to suppress or neutralize information crumbs that can subsequently be used to harm the user. The solutions audit user privacy settings, established online friends and contacts, and friend and contact activity online to limit the exposure and disclosure of user information online. The solutions perform white-hat penetration tests. The solutions report on user risk based on available online information. The solutions validate completed transactions based on monitored user movements and site visits. The solutions provide a crowd-sourced approach to identify risk based on common transactions and visits of others. The solutions prevent identity theft by verifying that disbursements are made to the correct entity.

### CLAIM OF BENEFIT TO RELATED APPLICATIONS

This application claims benefit of the United States provisional patent application entitled “Identity Protection” filed on Nov. 20, 2014 and having been assigned Ser. No. 62/082,377. The contents of provisional application 62/082,377 are hereby incorporated by reference.

### TECHNICAL FIELD

The present invention pertains to computer implemented forms of identity protection, especially in the field of online communications.

### BACKGROUND

Identity theft and identity fraud (hereafter collectively referred to as identity theft) affect millions of people every year. These are crimes in which a perpetrator obtains and misuses a victim's personal or confidential information, wherein the misuse involves leveraging the victim's identity to deceive or mislead others, harm the victim, or illegally benefit economically from the victim's identity.

Identity theft is a problem that continues to grow as more services are provided online and more transactions are conducted online. The more people that use these online services and the more transactions people conduct online, the more people expose the information (e.g., personal, confidential, or financial) that others can use to steal identities and perpetrate fraud. The exposed traces of information may be harmless in-and-of themselves. However, when this exposed information is pieced together by identity theft perpetrators, it can provide enough information to guess passwords, hack into accounts, or commit other forms of identity theft.

While the repercussions of identity theft can be long-felt, a majority of users are more likely to be hurt in other ways by their online activity. Online activity can become evidence in a court proceeding. Online activity can tipoff robbers as to when someone is not at home. Online activity can be collected by data mining companies that sell or make the compiled information available to advertisers. The advertisers can then provide targeted advertisements in a way that invades the privacy of some individuals. Further still, online activity can damage one's reputation. The damaged reputation can in turn affect employment, membership, or other situations where the individual's character is at issue.

Identity protection services exist, but they have been ineffective or limited to deal with the new realities of an ever-increasing online and connected world and the broader issue of identity fraud, theft, and protection. For instance, credit card companies provide zero liability protections in the event of identity theft, but do little to prevent the theft or fraud from occurring in the first place. LifeLock® has a broader reach and provides various solutions to the early detection of identity theft. However, these services do nothing to stem the broader issue of identity protection where information availability opens the door to identity theft.

Accordingly, there is a need for holistic and comprehensive identity protection systems and methodologies. As part of the holistic and comprehensive identity protection, there is a need to protect us from ourselves, especially with respect to the disclosure of potentially harmful information online. There is further a need to detect the misuse of any disclosed information and prevent the misuse from becoming the seeds for identity theft. Even in the event of identity theft, there is a need to rapidly detect and diagnose the root of the issue and prevent the harm from spreading.

### SUMMARY OF THE INVENTION

Some embodiments provide holistic and comprehensive identity protection solutions. The solutions protect user identity by screening the information trail that a user leaves behind online in order to suppress or neutralize information crumbs that can subsequently be used to harm the user. The solutions further include protecting user identity by auditing user privacy settings, established online friends and contacts, and friend and contact activity online to limit the exposure and disclosure of user information online. The solutions further include protecting user identity by performing white-hat penetration tests. The tests validate the potential misuses of the available online information and whether the exposed information can be used to gain unauthorized access to various user accounts as well as gain access to additional information through phishing. Some embodiments supplement the active identity protections with passive protections that assess and report on user risk directly based on available online information about the users and/or indirectly based on user activity, length of posts, and number of friends or contacts. In the event of a breach or instance of identity theft, the solutions limit the harm to a user's identity by detecting, diagnosing, and alerting the user to the breach or theft. Some embodiments do so by monitoring user movements and using the movement to validate that transactions occur while the user is present at a merchant location or is visiting a merchant site. Some embodiments use a crowd-sourced approach that identifies commonality in transactions conducted by a first set of users that have been victimized by identity theft in order to identify a second set of users with transaction histories having the commonality as the victimized first set of users and notifying the second set of users that they too are at risk. Some embodiments prevent identity theft and protect user identity through various verification solutions. The verification solutions operate by establishing a repository of verified user information. The verified user information is exposed to governmental agencies, merchants, and other third parties where identity theft can be used to misappropriate funds, goods, and services. The verification solutions verify the identity of a user requesting funds, goods, or services from a third party by ensuring that the funds, goods, and services are actually sent to the user and not another using the user's identity to acquire the funds, goods, and services. These solutions and their various embodiments are performed by specialized and proprietary systems and methodologies.

In some embodiments, the system monitors online activity of the user at various online sites. The monitoring involves identifying user information at the sites. This can include identifying posts published by the user, location check-ins of the user, and other information about the user that become publicly accessible. If disclosures are made that relate to categories that could lead to identity issues including identity theft, the system alerts the user to the unsafe information and potential misuses of the information. Some alerts include remediation steps for correcting the identified identity issue, thereby directly removing an online informational bread crumb from misuse. In some embodiments, the system automatically performs a remediation step on behalf of the user in response to the user accepting the step.

Rather than or in addition to screening each user disclosure, the system can alternatively protect user identity by ensuring broader policies are in place to limit who can access the user's disclosures. The system performs an audit of the user's privacy settings. As part of the audit, the system monitors online activity of the user at various online sites. The system analyzes the monitored online activity to determine the user's privacy settings at each online site as well as the amount of risk the current privacy settings expose the user to. If the risk exposure is acceptable, no actions are taken. If the risk exposure is unacceptable, the system alerts the user and optionally provides one or more remediation steps for lowering the risk exposure. In some such embodiments, the remediation steps include automatically adjusting the privacy settings at each site where the user faces unacceptable risk. In some embodiments, the user configures a level of risk exposure that the user is willing to accept.

Friends and contacts often are permitted a heightened level of access to user information than the public at large. Accordingly, the system of some embodiments audits the user's online friends and contacts at each of the online sites to ensure that they do not pose a risk of abusing or otherwise misusing their heightened level of access. The audit involves verifying the identity of the friends and contacts. The verification ensures that the profiles or accounts for the friends and contacts are human operated and are themselves not fraudulently created or hijacked.

As a user is more likely to interact and engage with posts from their friends and contacts, the system audit, in some embodiments, also extends to these posts. The system scrubs the posts published by the friends and contacts to ensure that they do not contain or link to a malicious attack. The user is alerted of any post found to contain a malicious attack. The alert may further include a remediation step for the system to automatically remove the post or remove the friend or contact publishing the post with the malicious attack.

Some embodiments protect user identity by validating the strength and security of the user's online accounts, profiles, and private information. In some embodiments, the system leverages the information it compiles on a given user to perform white-hat penetration tests that attempt to gain access to the user's online accounts and profiles. The system generates different sets of login credentials from the compiled user information. The sets of login credentials are then either applied to various sites or presented to the user. If the system can gain unauthorized access to the user accounts or profiles using the sets of login credentials, the system alerts the user that the user's passwords need to be changed or strengthened. The system alternatively validates the strength of the user's online accounts and profile by applying the collected information in order to gain unauthorized access through account or profile recovery processes of various sites where user accounts or profiles are registered. Other penetration tests for protecting user identity substantiate the user risk to external phishing. The system leverages the monitored user information in order to emulate the user or the user's friends or contacts. The more information the system compiles, the more accurately the system can emulate the user or the user's friends or contacts. Through the emulation, the system attempts to mislead others into providing additional information about the user. The system then reports its findings to the user and notifies the user of corrective action that is needed to prevent the emulation and phishing.

Passive identity protections can be provided in addition to or instead of some of the above identified active identity protections. The passive identity protections provide a user with regular reports regarding the vulnerability of the user's identity. As part of the passive identity protections, the system monitors the user's online activity and collects user information from each of the monitored sites. The collected information is compiled to a risk assessment report. Within the report, the collected information is compared against a checklist of common information that when exposed increases the user's risk to identity issues including identity theft. In some embodiments, a risk score is computed based on how complete the checklist for a given user is. The system can also evaluate the user's risk exposure through indirect monitoring of the user's online activity. The indirect monitoring includes monitoring the number and frequency of posts published by the particular user, the length of the posts, and number of friends or contacts of the particular user.

In addition to the various preventative solutions above, comprehensive and holistic identity protection includes detection and mitigation. In other words, the system should limit the harm to a user's identity in the event a breach or theft does occur. The system does so by periodically tracking a user's location using geolocation coordinates obtained from the user's mobile device. The system also obtains a list of transactions that were made by the user as well as a timestamp and location of each transaction. For each transaction, the system obtains a transaction timestamp and retrieves the user's location at that time. To verify a transaction, the system checks that the user was at or near the location of the merchant where the traction occurred. A retail transaction is deemed to be not authorized when the user is not at the merchant location when the transaction takes place. To verify an online transaction, the system accesses the user's browser history and determines if the user visited a site from registered devices at or near a time when a transaction was completed by a merchant associated with the site. The system alerts the user of any unauthorized charges. The user can then verify the charges or verify that the charges were unauthorized.

Some embodiments provide a crowd sourced evaluation for a user's exposure to identity theft. The system aggregates a list of users that have recently been victims of identity theft. The system retrieves a purchase history of the victims and identifies commonality therein. Specifically, the system identifies purchases of a common item or purchases made at a common merchant to identify the source of the theft. The system then notifies other users that have not yet been victimized, but that have made purchases of the common item or at the common merchant, that they are at risk and should take preventative action including any of changing of passwords or canceling charge cards. Instead of obtaining the purchase history of the victims, some embodiments leverage browsing history of the victims to identify a commonly visited site that could be the source of the theft. In this case, the system notifies other users that have also visited the commonly visited site but that have not yet been victimized that they are at risk and should take appropriate preventative action. In some embodiments, the system also provides notification to the merchant or site that is the source of the theft. In some embodiments, the system generates a risk assessment report to identify sites, merchants, regions, industries, or users that may be at risk of identity theft based on observed commonality amongst known victims.

In some embodiments, the system provides verification services to protect user identity. A registered user provides the system with verified information. The verified information includes social security numbers, street addresses, email addresses, telephone numbers, bank account numbers, and other identifying information. The verified information is unique to the user and is exposed by the system to third party partners. When a user requests funds, goods, or services from a third party partner, the partner verifies the information against the verified information of the system to ensure that the funds, goods, or services are sent to the user and not another.

### BRIEF DESCRIPTION OF THE DRAWINGS

In order to achieve a better understanding of the nature of the present invention, a preferred embodiment will now be described, by way of example only, with reference to the accompanying drawings in which:

FIG. 1 presents a process implementing the preventative solution in accordance with some embodiments.

FIG. 2 conceptually illustrates the system protecting a particular user's identity from potentially harmful disclosures.

FIG. 3 presents a process for auditing a user's privacy settings in accordance with some embodiments.

FIG. 4 presents a process for auditing online friends and contacts of a user in accordance with some embodiments.

FIG. 5 presents a process for passive identity protection in accordance with some embodiments.

FIG. 6 conceptually illustrates a risk assessment report in accordance with some embodiments.

FIG. 7 conceptually illustrates detecting identity theft based on the user location in accordance with some embodiments.

FIG. 8 conceptually illustrates detecting identity theft that occurs in online transactions in accordance with some embodiments.

FIG. 9 presents a process providing a crowd-sourced approach to the detection and prevention of identity theft in accordance with some embodiments.

FIG. 10 illustrates preventing identity theft by preventing the misuse of misappropriated information in accordance with some embodiments.

FIG. 11 illustrates a computer system with which some embodiments are implemented.

### DETAILED DESCRIPTION OF THE INVENTION

In the following detailed description, numerous details, examples, and embodiments are set forth and described. As one skilled in the art would understand in light of the present description, the system and methods are not limited to the embodiments set forth, and the system and methods may be practiced without some of the specific details and examples discussed. Also, reference is made to accompanying figures, which illustrate specific embodiments in which the invention can be practiced. It is to be understood that other embodiments can be used and structural changes can be made without departing from the scope of the embodiments herein described.

Some embodiments provide various online identity protection solutions. The solutions are comprehensive and holistic in that they prevent user identity from becoming compromised, detect when user identity is compromised, and mitigate the damage that results from a compromised identity. As such, the identity protection solutions encompass and expand upon credit protection services, identity theft protection services, and identity fraud protection services of the prior art. Moreover, the identity protection solutions of some embodiments expand to protect user online activity where much of credit fraud, identity theft, and identity fraud originates.

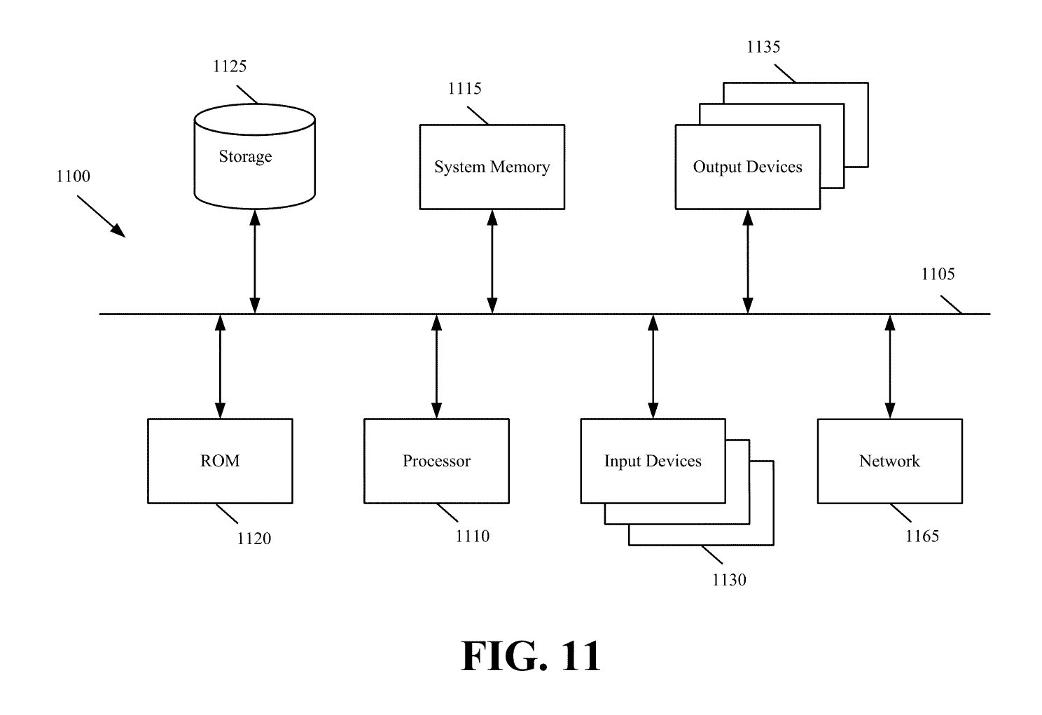

The identity protection solutions and their various embodiments described below are performed by specialized and proprietary systems and methodologies. The hardware components implementing these systems and methodologies are presented and described with respect to FIG. 11. In some embodiments, the systems are implemented through an application that a user installs on a network enabled device and one or more back-end machines that monitor and protect user identity as described below. The application interfaces with back-end systems and provides the front-end interface through which users are notified of possible theft or fraud and are further notified of corrective actions to resolve any such issues.

I. Disclosure Protection

Many users do not know or unaware that the information they post online can cause them subsequent harm. The potentially harmful information can be contained in various online posts including text based messages, blogs, reviews, comments, location check-ins, status updates, images, likes, interests, relationship status, occupational history, educational history, etc. Any of these posts can be published to social media sites, such as Facebook and Twitter, or any other online site. The harm resulting from the user posts can range from minor annoyances to major inconveniences. This includes having information posted online be sold or passed to advertisers, marketers, and spammers, having information posted online be used in legal proceedings, and having information posted online be misused in criminal activity including identity theft, fraud, or home invasion robberies. Even seemingly insignificant information such as the name of a pet, former school, and mother's maiden name can be used to gain unauthorized access to a user's account. The resulting harm can also be the byproduct of a damaged reputation, wherein one's reputation affects employment, membership, and other opportunities where one's character is at issue.

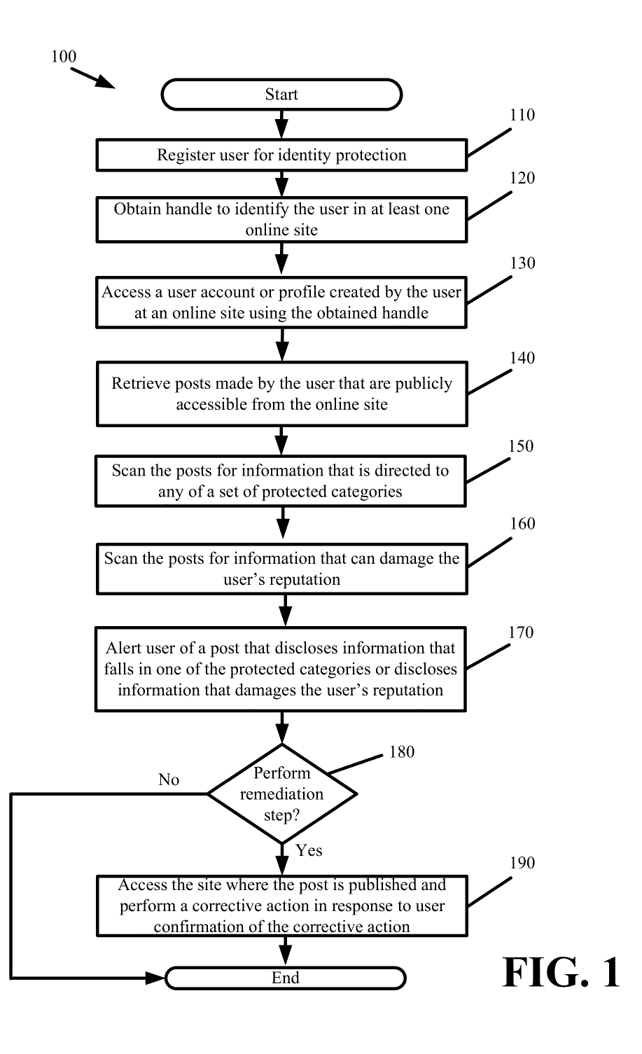

The comprehensive and holistic identity protection provided by some embodiments includes a preventative solution that screens the information trail that a user leaves behind online in order to suppress or neutralize information crumbs that can subsequently be used to harm the user. FIG. 1 presents a process 100 implementing the preventative solution in accordance with some embodiments.

The process 100 commences by registering (at 110) the user for identity protection. In some embodiments, registration involves obtaining basic identifying information about the user. Users may register using the system front-end application, The user installs the front-end application on a network enabled device, enters the registration identifying information, and the application transfers the identifying information to the system back-end. The system may query an entity database using the basic identifying information in order to obtain additional information about the user. Additionally, the system may verify the user's identity as part of the registration.

The process then obtains (at 120) a handle to identify the user in at least one online site. The handle could be the user's name or an identifier for a profile or account of the user at the online site. In some cases, the user provides a list of handles as part of the registering step. The list of handles identities different accounts or profiles that the user has registered with various online sites. The list of handles could alternatively include the login credentials for each of the user accounts or profiles. The system may alternatively use the basic user identifying information to query search engines and site specific search functionality in order to identify the various accounts or profiles that the user has created.

Using the obtained handle, the process accesses (at 130) a user account or profile created by the user at an online site. Specifically, the system back-end establishes a network connection to the online site and navigates to the user account or profile. The process retrieves (at 140) posts made by the user that are publicly accessible from the online site to the system back-end.

Next, the process scans (at 150) the posts for information that is directed to any of a set of protected categories. The set of protected categories identify information types and specific information that can potentially harm the user or create identity issues. This can include personal identifying information, confidential information, and financial information. Examples of such information include user name, mailing address, telephone number, email address, birth date, social security number, current and previous relationship status, names of family members, names of pets, school history, employment history, user location (based on check-ins or tracking), user travel plans, future events or engagements, prior addresses, bank accounts, credit cards, loans, and financial decisions such as buying a house. The set of protected categories can further include information about others including relatives, friends, and coworkers of the user. Generally, the set of protected categories protect against the unwanted disclosure of information that could reveal user passwords, information that could reveal answers to identity or account recovery questions, and information that could aid another looking to steal the user's identity or commit fraud using the user's identity.

To assist in the identification of information that is directed to the set of protected categories, the user may provide the system with personal, confidential, financial, and other private information at the time of registration. For example, the user provides his telephone number to the system so that the system can recognize it when it is disclosed in a post at an online site. Otherwise, information that is directed to one of the set of protected categories can be identified by the information format or surrounding context in some embodiments.

In addition to scanning the posts for information that is directed to any of a set of protected categories, the process can also scan (at 160) the posts for information that can damage the user's reputation. In this step, the process searches for opinioned statements, criminal background information, group affiliations, inconsistent or inaccurate statement of facts, grammar or spelling issues, inappropriate or unprofessional language or acts, and statements against current and former employers or coworkers. Employers, investors, and others looking to engage with the user can be deterred by such information disclosures.

Accordingly, when the process discovers a post that discloses information that falls within one of the set of protected categories or discloses information that can damage the user's reputation, the process alerts (at 170) the user of the post. The alert can further identify the specific information from the post that is potentially unsafe or that potentially harms the user's reputation as well as the harm that can result from the post. The alert can also provide a remediation step. In some embodiments, the remediation step is an automated action that the system can perform on behalf of the user to remove the potential harm associated with the identified post. The user has the option to accept or reject the remediation step. In some embodiments, the remediation step is embedded with a Uniform Resource Locator (URL) or other link that causes the system back-end to perform the identified remediation step should the user invoke the remediation step. The process sends the alert from the system back-end to the front-end application installed and running on the user device. In some embodiments, the alert activates the front-end application to cause the application to present the potentially unsafe post, the potential harm, and the remedial action to the user. Activating the front-end application involves establishing a connection over the Internet between the device on which the front-end application runs and the system back-end when the user device comes online.

If the user accepts (at 180) the remediation step, the process invokes the system back-end to automatically access (at 190) the site where the post is published and performs a corrective action. As noted above, the user can accept the remediation step by selecting the URL or link that is included with the identified remediation step in the alert. The correction action can include deleting the post or editing the post to remove the potentially harmful information. In order to perform the corrective action, the system may need access to the user account or profile at issue which the user may provide in the form access credentials during the registering step. If the remediation step is successful, the user is alerted via the application running on the user device. If a remediation step cannot be performed by the system, the process may instruct the user on the actions he should take to safeguard himself from the potential harm. Process 100 is continually executed to ensure that new posts do not fall within the protected categories and to provide continued protection for the user.

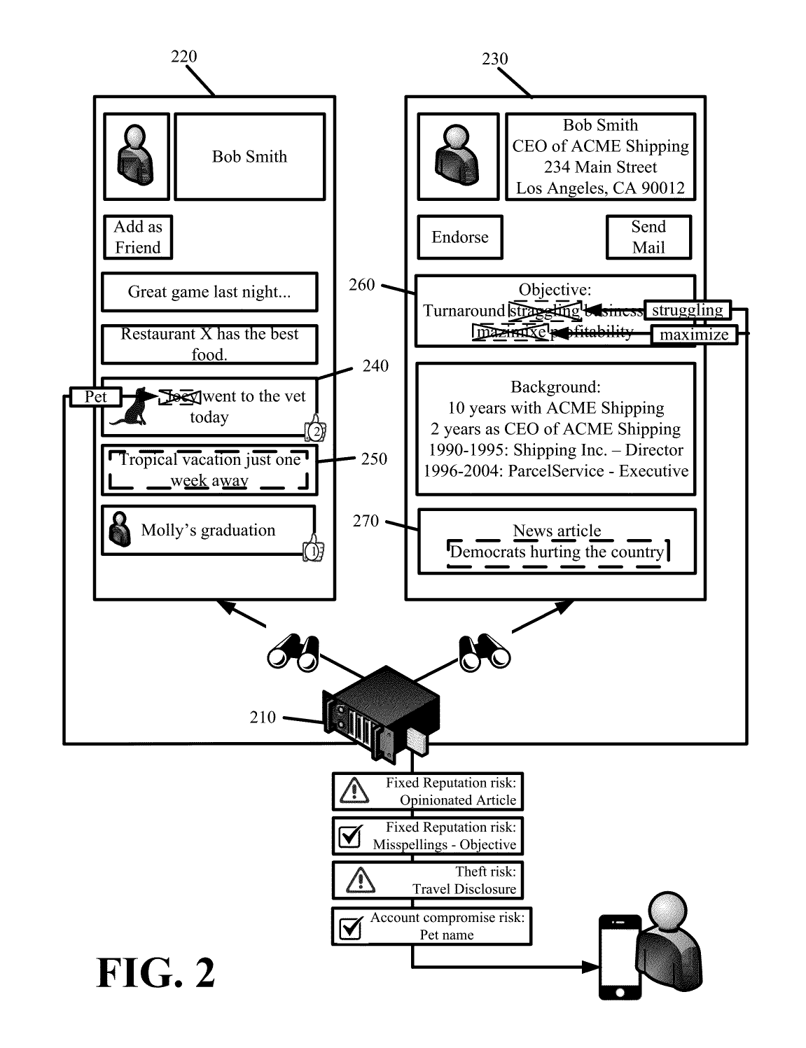

In accordance with some embodiments, FIG. 2 conceptually illustrates the system protecting a particular user's identity from potentially harmful disclosures. As shown, the system 210 monitors the particular user's online activity at two different online service providers 220 and 230. At each online service provider 220 and 230, the system searches for and accesses a site presenting public posts made or directed to the particular user.

In scanning the posts published to the first online service provider 220, the system identifies two potentially harmful posts 240 and 250. The first post 240 contains a picture of the particular user's pet and the name of the pet. As noted above, a pet name is commonly used for recovering a lost password. As such, this information poses a risk to protecting the particular user's identity as it increases the particular user's risk of identity theft. Accordingly, the first post 240 is flagged as potentially harmful. The second post 250 reveals that the particular user is traveling away from home. This information also poses a risk to protecting the particular user's identity as it provides a robber with valuable information as to when the particular user's home is vacant.

In scanning the posts published to the second online service provider 230, the system identifies two potentially harmful posts 260 and 270. The harm potentially resulting from these posts is altogether different than the harm from posts 240 and 250. Post 260 contains various misspellings and grammatical errors while post 270 discloses strongly opinionated political statements. These posts 260 and 270 pose a risk to protecting the particular user's identity because it allows outside parties (e.g., potential employers, investors, or partners) to form an opinion about the particular user prior to any interaction or engagement with the particular user. The particular user can therefore be prejudiced as a result of his/her own posts with such prejudice affecting the particular user's economic, employment, or other future opportunities.

The system 210 alerts the particular user about the potential harm resulting from posts 240-270. The system 210 also performs a remediation action with respect to posts 240 and 260 per request of the particular user. The remediation action involves editing post 240 to remove the pet name and editing post 260 to correct the misspellings.

II. Audit Protection

Some embodiments alternatively or additionally protect a user's identity by ensuring broader policies are in place to limit access to the user's disclosures. These broader policies are effectuated by adjusting the privacy settings of the various sites and service providers where the user conducts online activity.

Social media sites, like Facebook and Google+, and networking sites, like LinkedIn, have user configurable privacy settings. The privacy settings control what user information on the site becomes publicly accessible and what user information on the site remains private and accessible in a limited fashion. In some cases, user information that is made private is accessible by the user's designated friends or contacts. In other cases, user information that is made private is not accessible to any third party. Some users are unaware of the privacy settings while others defer to a default setting that may not provide sufficient protections for the users' identity.

To protect the user's identity from unacceptable risk stemming from improperly configured privacy settings, some embodiments audit privacy settings for a particular user across various sites and services providers where the user conducts online activity. The audit determines the amount of risk to the user's identity based on the amount of user online activity and the user's current privacy settings at each online site. If the risk exposure is acceptable, no action is taken. If the risk exposure is unacceptable, the system alerts the particular user of the risk and optionally provides one or more remediation steps for lowering the risk exposure. In some such embodiments, the remediation steps include automatically adjusting the privacy settings at each site where the particular user faces unacceptable risk. In some embodiments, the user configures a level of risk exposure that the user is willing to accept.

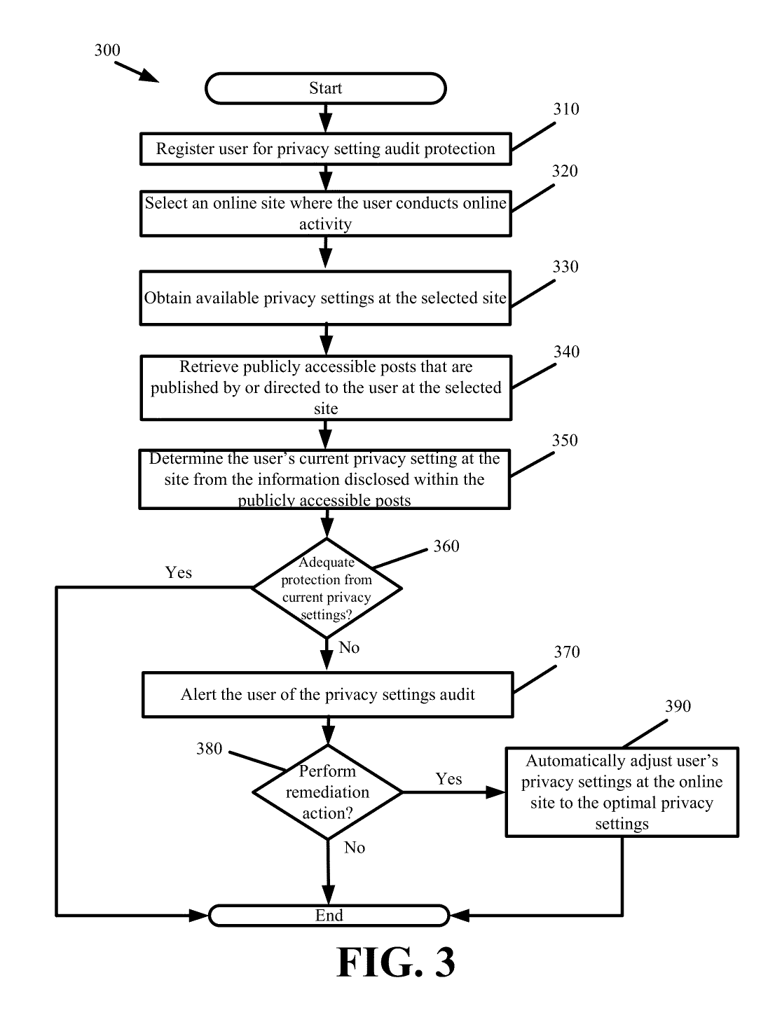

FIG. 3 presents a process 300 for auditing a user's privacy settings in accordance with some embodiments. The process 300 commences by registering (at 310) a user. Here again, registration involves installing the application front-end on the user device through which the user can then identify handles for accounts or profiles where the user publishes posts or conducts other online activity. Alternatively, the user may provide basic identifying information from which the system automatically identifies the user's accounts or profiles.

The process by operation of the system back-end then selects (at 320) an online site where the user conducts online activity. The process obtains (at 330) the available privacy settings at the selected site. In some embodiments, the system is preconfigured to identify the available privacy setting for various online sites.

The process then retrieves (at 340) publicly accessible posts that are published by or directed to the user at the online site. The process retrieves the publicly accessible posts by using or searching for the user handle at the site.

From the information disclosed within the publicly accessible posts, the process determines (at 350) the user's current privacy setting at the site. For example, the system can distinguish between first and second privacy settings based on whether the user's posted pictures are publicly accessible or not. Another way to ascertain the user's current privacy settings at an online site is to determine whether posts related to certain fields (e.g., education, interest, etc.) are publicly accessible. From the information disclosed within the publicly accessible posts, the process further determines (at 360) if the current privacy setting provides inadequate protection for the user's identity. In some embodiments, the determination at step 360 is based on the number, frequency, and content of the user's posts. For example, if a first user only posts links to articles that the first user likes, then a less restrictive privacy setting adequately protects the first user's identity. However, if a second user posts text about daily and future activity or communications with friends, then the same less restrictive privacy setting inadequately protects the second user's identity, thereby exposing the second user to increased risk. Similarly, if a third user gossips about others frequently, the third user can harm his reputation by allowing those posts to become publicly accessible. Therefore, a less restrictive privacy setting would inadequately protect the third user's identity.

If the currently configured privacy settings provide adequate protection, then no action is needed or taken and the process 300 ends or a next site where the user conducts online activity is selected for privacy setting auditing. If the currently configured privacy settings do not provide adequate protection, the process alerts (at 370) the user of the privacy settings audit. The alert is sent over the Internet from the system back-end to the front-end application running on the user device. The alert presents the audit results on the user device. The alert identifies the identity theft risk posed by the by the overly lax privacy settings and further provides the user with optimal privacy settings in light of the quality and quantity of the user's online activity. The optimal privacy settings are the privacy settings that best protect the user's identity at the online site at issue without being overly restrictive in what the user can publicly disclose. As part of providing the user with the optimal privacy settings, the alert can further include a remediation action. The remediation action is a URL or link that the user can invoke from within the front-end application to cause the system back-end to automatically adjust the user's current privacy setting at the site to the identified optimal privacy settings. Should the user invoke (at 380) the remediation action, the process automatically adjusts (at 390) the user's privacy settings at the online site to the optimal privacy settings without user involvement. To do so, the system requires the user to provide login credentials to the online site at issue during the registering step 310. The front-end application forwards the login credentials to the system back-end for keeping until the remediation step is invoked. A system back-end executed script uses the login credentials to access the user account and change the privacy settings therein. Process 300 continues until the user's privacy settings at all online sites where the user conducts online activity are audited.

Some embodiments also audit friends or contacts of a user across different sites and service providers where the user conducts online activity. Users sometimes add friends or contacts that are mere acquaintances or add them for the sake of increasing one's network. As such, these friends or contacts are not well known to the user or are entities that the user does not actively engage with. These friends or contacts can pose different risks to the user's identity. In some cases, entities establish a friend or contact relationship with a user in order to gain heightened access to user information that is not publicly accessible but is accessible to the user's friends or contacts. In other cases, entities establish a friend or contact relationship so that they may directly communicate with the user with the direct communication channel opening up avenues with which the entities can conduct different phishing schemes in order to collect user information for malicious or improper uses. In other cases, friends or contacts can knowingly or unknowingly post content or links that contain a malicious attack. The user, being trusting or interested in the posts of his friends or contacts, is more likely to access these posts, thereby making the user more susceptible to such attacks. Accordingly, some embodiments provide a system and methodology to prevent identity theft by auditing one's online friends or contacts.

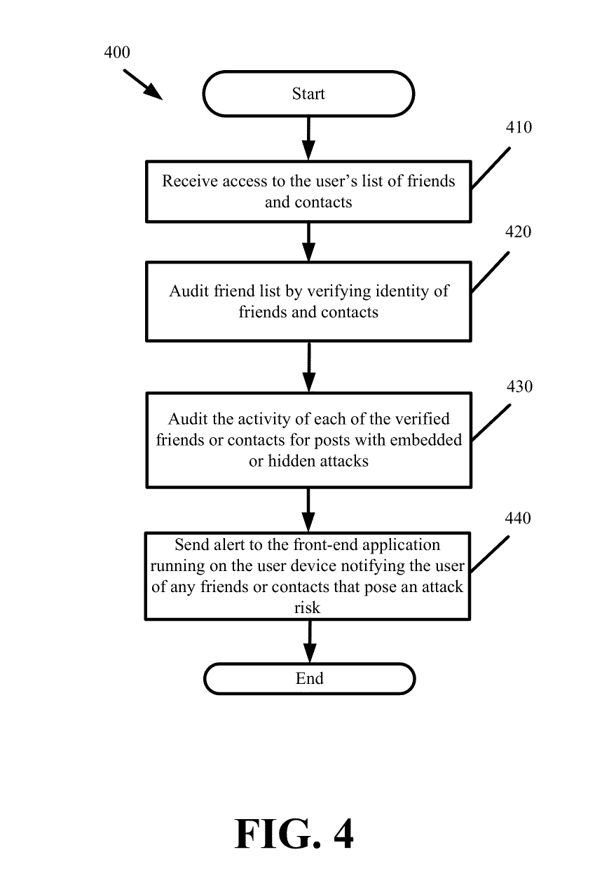

FIG. 4 presents a process 400 for auditing online friends and contacts of a user in accordance with some embodiments. The process 400 commences when the system receives (at 410) access to the user's list of friends and contacts at one or more sites where the user has such relationships. In some embodiments, the system obtains access to the user's list of friends and contacts by having the user add the system back-end (i.e., a system created profile or account) as a friend or contact of the user at the various sites. For example, if the system is to audit the user's Facebook friend list, the system back-end sends a friend request from its own Facebook profile to the user's profile. Once the user accepts the request and adds the system profile as a friend, the system gains access to the user's friend list. Similar steps can be performed to provide the system with access to the user friend or contact list at other sites.

Next, the process audits each of the user's friends or contacts. The friend or contact audit involves the system back-end verifying (at 420) the identity of the friends and contacts. The system can verify the identities in several different ways.

In some embodiments, the system verifies an identity by accessing the friend or contact profile and by monitoring for valid activity thereon. Monitoring for valid activity includes identifying common friends or contacts shared by the user at issue and the friend or contact at issue. Having common friends or contacts provides some degree of validation that the friend or contact at issue is genuine and not a profile that is created only to attack the user. Monitoring for valid activity can also include scanning for other activity on the friend or contact profile that indicates that the friend or contact is an actual person and not a machine automated and controlled profile. This can include monitoring for pictures with at least one common person or contextually relevant text within posts published by the friend or contact at issue.

In some embodiments, the process verifies a friend or contact's identity using external data or external sources. In some such embodiments, the system accesses the profile of the friend or contact at issue and obtains identifying information from the profile. The identifying information can include any of a name, mailing address, telephone number, age, physical characteristics, past history, etc. The system then attempts to corroborate the information with external sources including other social network sites, credit reporting agencies, entity databases, etc. If the information cannot be corroborated, then there is an increased possibility that the friend or contact at issue is fraudulently represented.

In some embodiments, the system verifies a friend or contact's identity by submitting a short questionnaire to the friend or contact. Should the friend or contact respond with correct answers to the questionnaire, the system can verity that friend or contact's identity.

In some embodiments, the system verifies a friend or contact's identity by conducting a background check. The background check reveals if the friend or contact is involved or associated with the collection or misuse of information.

The process also audits (at 430) the activity of each of the user's verified friends or contacts. In some embodiments, auditing friend or contact activity involves scanning posts published by the friends or contacts for any embedded or hidden malicious attacks. More specifically, the system scans for any friend or contact posts that contain links to external content or sites. The system inspects the links to ensure that they do not contain a virus, a redirect to a different site (e.g., phishing site or fraudulent site), or a malicious script as some examples.

Based on the audits above, the process sends (at 440) an alert to the front-end application running on the user device. The alert activates the front-end application to display a notification of any friends or contacts that pose an attack risk to the user. As part of the notification, the process may identify the risks that are presented by each friend or contact in the notification. The risks are determined based on the manner with which the system back-end identifies a contact to be an attack risk. For example, the alert can identify a first contact as a fraudulent account for not having any common contacts or valid activity, and identify a second contact as an attack risk for publishing posts with embedded attacks or links to attacks. This alert may be combined with or sent separate from the privacy settings audit alert described with reference to FIG. 3 above. The alert notifying the user of contacts that are attack risks may also provide a remediation step to cause the system back-end to remove any posts submitted by friends or contacts that contain a malicious attack or to remove any friends or contacts that pose a threat to the user's identity. Process 400 therefore compliments the privacy settings audit of process 300 by alerting the user as to any friends or contacts that pose a risk to the user's identity and that can bypass the privacy controls because of their heightened access granted through their relationship with the user.

In some embodiments, the system audits the strength and security of a user's identity online by performing white-hat penetrations tests using publicly accessible information about the user. The white hat penetration testing involves the system back-end leveraging the publicly accessible user information to gain unauthorized access to the user's various online profiles and accounts and to user private information. The white hat penetration tests are automated routines that model various hacking and phishing techniques that perpetrators use to gain unauthorized access to user profiles, accounts, and private information.

The white-hat penetration tests begin with collecting publicly accessible posts about the user. To do so, the system back-end monitors user activity at various online sites. This includes collecting posts that are published by the user or are directed to the user at any of a plurality of sites where the user is registered with an account or is otherwise identified. A similar process as process 100 can be performed for the information collection phase of the audit.

The system back-end then filters the collected posts to retain those with information falling within one of the set of protected categories described above or information that can harm the user's reputation. In other words, the system back-end looks for posts that contain revealing information about the user. The retained information can be ranked based on the number of instances the same information appears in the collected posts. In some embodiments, the ranking is used to prioritize the information for the white-hat penetration tests. The filtered and ranked information is then used to conduct one or more white-hat penetration tests.

In some embodiments, the white-hat penetration tests include attempting to gain access to a user profile or account by completing lost username and lost password procedures or similar account recovery procedures at a site where a user profile or account is registered using the filtered and ranked information. For example, the process will attempt to reset the user's password by answering a series of security questions with the filtered information.

If the system back-end successfully completes an account recovery procedure or is able to obtain or change a previous password, an alert is immediately generated and sent to the front-end application running on the user's device. As before, the alert activates the front-end application on the user device to cause the information about the compromised user account to be displayed. In some embodiments, the alert notifies the user of a particular account registered at an online site that can be hacked using publicly accessible information posted by the user or his contacts. The alert may also provide the user with the information used to gain access to the account and where that information was collected from, including the specific site URL and post. The alert may also a remediation step which when selected by the user causes the system back-end to remove or change the online postings that reveal the information from which the system back-end was able to gain access to the user account. The remediation step may also include generating a new secure password for the user.

In some embodiments, the white-hat penetration tests include generating passwords based on the filtered information. The generated passwords can be sent in an alert to the front-end application running on the user device for presentation to the user. Alternatively, the system back-end can provide the login credentials to various sites where the user has registered a profile or account. In presenting the list generated passwords to the user, the system notifies the user that if any of the passwords in the list are actual passwords used by the user, that the user should change those passwords immediately. Similarly, if the system is able to gain unauthorized access to the user profile or account at an online site, the system will notify the user to change the login credentials at that online site.

In some embodiments, the white-hat penetration tests include phishing additional information about the user using the filtered and ranked information. Specifically, the system leverages the filtered and ranked information to emulate either the user or a friend or contact of the user.

To emulate the user, the system creates an account or profile at an online site using the filtered information about the user with the created account or profile appearing as if it represents the user. The more information the system is able to collect on the user, the better it is able to emulate the user. A fully emulated user account or profile will include one or more recent pictures of the user as well as a complete or comprehensive information history about the user. Through the created account or profile, the system attempts to contact friends or contacts of the user as identified from the same or different online site. The system poses questions or leading statements that attempt to extract additional private information about the user from the friends and contacts. A fully emulated user account or profile will make the friends and contacts less suspicious of the contacts, thereby making it easier for the system to extract additional information about the user from the friends and contacts. The system then generates and provides the user with an audit report. The audit report details how well the user's identity can be copied using publicly accessible information and how much information can be stolen as a result. In other words, the audit report makes the user wary of the information the user discloses online.

From the filtered information, the system can also identify a friend or contact of the user to emulate. In some such embodiments, the system emulates a friend or contact of the user to determine the user's inability to distinguish the real friend or contact from a fraudulent friend or contact and the user's propensity to disclose additional information to the emulated friend or contact. The system collects information about that the friend or contact in a similar manner as collecting the information about the user. The system poses as the friend or contact. In some embodiments, the system creates an account or profile for the friend or contact using the collected information at an online site where the user is also registered. The system contacts the user from the emulated friend or contact account and poses various questions or leading statements that attempt to extract additional private information about the user directly from the user. Here again, the system generates an audit report based on the amount of information that the system extracts from the user.

III. Risk Assessment

Some embodiments passively protect a user's identity by generating regular risk assessments reports that assesses the vulnerability of the user's identity. The risk reports result from passive monitoring of the user's identity online.

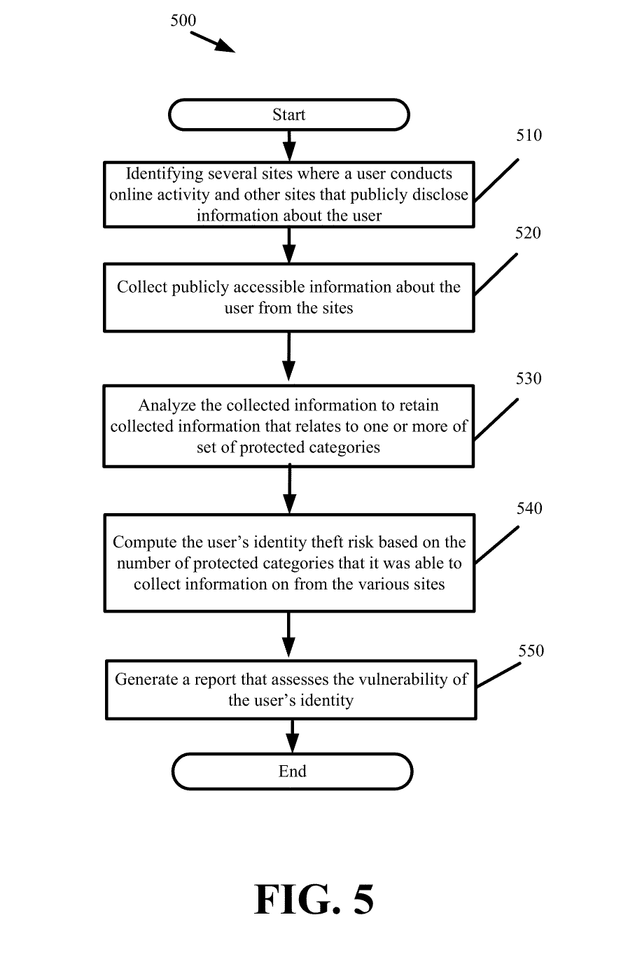

FIG. 5 presents a process 500 for passive identity protection in accordance with some embodiments. The process 500 commences by identifying (at 510) several sites where a user conducts online activity and other sites that publicly disclose information about the user. In some embodiments, the system back-end identifies registered profiles of the user at some of the sites. In some embodiments, the system back-end searches for and identifies any sites that disclose information about the user irrespective of whether or not the information is provided by the user.

The process collects (at 520) the publicly accessible information about the user from the sites. Next, the process analyzes (at 530) the collected information to retain collected information that relates to one or more of set of protected categories or information that can harm the user reputation. Other information can be discarded.

The process computes (at 540) the risk to the user's identity based on the number of protected categories that it was able to collect information on from the various sites as well as the amount of information that can harm the user's reputation. The more such information the system is able to collect, the higher the user's risk to identity theft, reputation harm, and other misuse. This is because perpetrators will look to leverage that same information to hack into the user's profile, harm the user's reputation, or steal personal or confidential information from the user's profile among other risks.

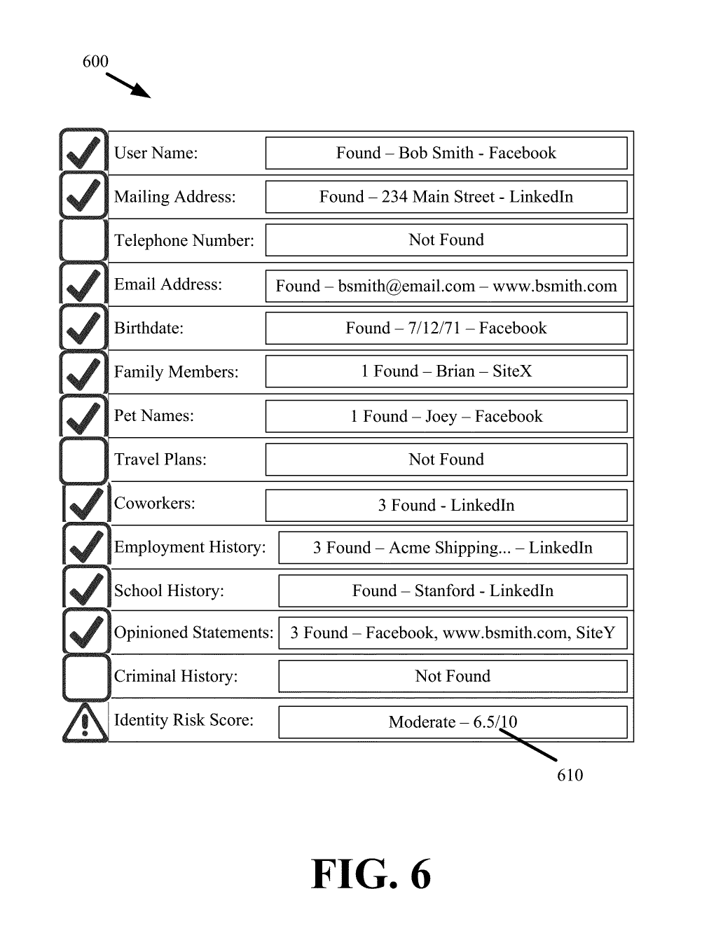

The process generates (at 550) a report that assesses the vulnerability of the user's identity. The report is then sent as an alert from the back-end system over the Internet to the front-end application running on the user device. The alert activates the front-end application to cause the report to display on the user device. In some embodiments, the alert contains a URL or link to the report contents such that the alert also enables a connection via the URL or link to the system back-end over the Internet in order to retrieve and present the report when the user device has network connectivity. FIG. 6 conceptually illustrates such a report 600 in accordance with some embodiments.

The report 600 illustrates information that is collected from various sites where the user conducts online activity and that is included in the report. The information is formatted according to a checklist The checklist identifies the various protected categories and other information categories that can be harmful to the user's reputation. Adjacent to each item of the checklist is any information collected by the system that relates to the item and the site where that information was obtained. This format allows the user to quickly observe how much sensitive information about the user is available online, wherein the sensitive information could potentially be used to harm the user's identity. The user's risk increases with each additional checklist item that is populated. The report facilitates user identity protection because it allows the user to quickly identify the source of the exposed information such that the user can interact with the source to remove or request removal of the sensitive information.

To summarize the risk for the user, the report of some embodiments further includes an identity risk score 610. The score 610 is derived based on the number of checklist entries that the system is able to populate with potentially misusable information and based on the sensitivity of the information items. Some information items pose a larger risk to the user's identity than others. As such, the information items posing the larger risk are factored more heavily in the derivation of the risk score 610. Although the risk score 610 is shown as a numerical value, it should be apparent that the risk score 610 can have many other embodiments including any alphanumeric or symbolic representation.

Some embodiments provide or supplement the passive identity protection by assessing a user's identity risk from the number and frequency of the user's posts, the length of the posts, and the number of friends or contacts of the user. These metrics relate to the user's level of information exposure. As the user's level of information exposure increases, so too does the risk of exposing potentially harmful information.

The number and frequency of the user's posts indicate how much information the user discloses online. More posts and more frequent posting increase the user's risk of disclosing information within a protected category or a category that can harm the user's reputation.

Moreover, the more online activity the user is involved in, the more difficult it becomes to identify unauthorized activity from authorized activity.

When monitoring user online activity, the system also measures the average length of user posts. The system measures the length of a post according to the number of characters or words of that post. The greater the post length, the greater the likelihood of the user disclosing potentially harmful information, which in turn, increases the user's identity risk.

A third metric with which the system assesses the user's identity theft risk is by assessing the number of friends or contacts that the user has. Whenever a friend or contact is added by the user, that friend or contact is provided access to some set of confidential information about the user. The confidential information can include contact information such as an email address, telephone number, or address of the user. The confidential information can include posts made by the user that the public does not have access to. Generally, the confidential information can include any information that the user has set as private. As such, the more friends or contacts the user adds, the more the user's information is exposed, which in turn, increases the risk of others exposing the user's information.

Some embodiments therefore monitor a user's online activity in order to ascertain the number and frequency of the user's posts, the length of the posts, and the number of friends or contacts of the user. The system then quantifies the metrics to derive a risk assessment that can be included as part of the FIG. 6 report, identity risk score 610, or included in a separate report.

IV. Theft Detection

Identity protection involves prevention, detection, and remediation or mitigation. In the event that a user's identity is compromised, the next step in identity protection is detection. This is especially important when misuse of a user's information leads to identity theft or identity fraud. In such cases, perpetrators open lines of credit, purchase items, and cause other financial harm that is attributed to the victimized user. Early and effective detection limits the user's loss and allows the user to take corrective action before the harm becomes too great.

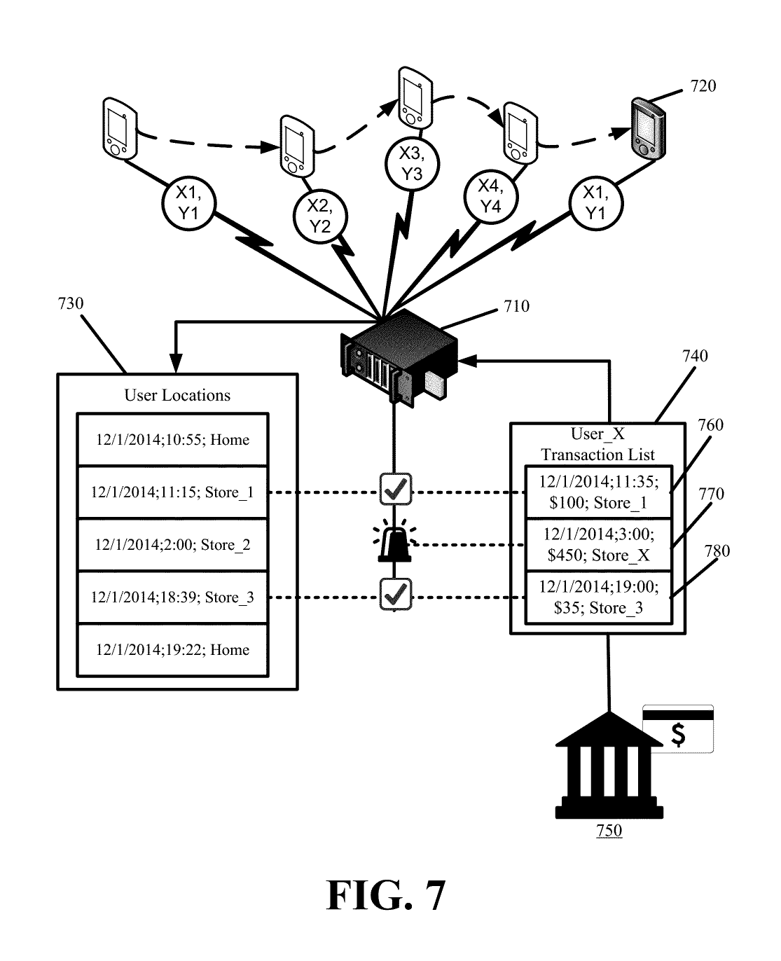

Some embodiments provide a system and methodology for detecting identity theft by cross-referencing a user location or activity at the time of a transaction with the transaction location. FIG. 7 conceptually illustrates detecting identity theft based on the user location in accordance with some embodiments.

The identity theft detection system 710 of some embodiments periodically (e.g., every ten minutes) obtains a user's location from the user's mobile device (i.e., smartphone) 720. The system 710 does so by accessing geolocation services of the user's mobile device 720. The user grants the system 710 such access in exchange for the identity theft detection services. The access is granted when the user installs a system provided application on the user's mobile device 720. The application runs in the background and periodically sends coordinates (e.g., latitude and longitude) identifying the user's location to the system 710. This application operation is minimally invasive and has little to no impact on the user device.

When the system 710 receives location coordinates, the system 710 associates the location coordinates to a particular user based on an identifier of the mobile device passing the location coordinates. In some embodiments, the system maps user location coordinates to specific merchant locations. For location coordinates that do not map to a specific merchant location, the system may delete those coordinates or map them to other location identifiers. The system also associates a timestamp to indicate when the user was at the location identified by the location coordinates. The system stores the received user locations with the associated timestamps to a user location database 730.

The system 710 also obtains a list of transactions 740 that have been charged to one or more user accounts. In some embodiments, the system 710 obtains access to the transaction list through agreements with credit card companies, payment processors, banks, or other third party transaction aggregator or processors (i.e., 750). Transaction processors may be inclined to allow the system access to the user transaction lists as the system's identity theft detection services can help the transaction processors mitigate losses. The user may also provide the system access to the transaction list by granting the system login credentials to access the user account at the transaction aggregators or processors. The transaction list 740 for different users may be obtained daily, weekly, or with some other frequency. The transaction list 740 includes at least one identifier and a timestamp. The identifier identifies a merchant or merchant point-of-sale (POS) where each transaction was completed. In some embodiments, the system 710 maps each identifier to a merchant location. The mapping may involve converting the identifier to a merchant name and obtaining a street address or coordinates (i.e., longitude and latitude) for a storefront of the merchant. The timestamp identifies the date and time when each transaction was completed.

The system 710 then attempts to match the user's location to each transaction location. The system 710 does so by obtaining a transaction timestamp and a mapped location for the merchant where that transaction was completed. The system then scans the obtained user location timestamps from the user location database 730 to determine the user's location at or near the transaction timestamp.

If the user location matches the transaction merchant location and the timestamps associated with the user location are contemporaneous with the transaction timestamp, the system 710 verifies that the first transaction is valid. In FIG. 7, the system 710 verifies transactions 760 and 780 in this manner. In some embodiments, the system back-end notifies the transaction processor of any verified transactions.

If none of the user locations match the transaction merchant location at or near the transaction timestamp, the system 710 flags the transaction as potentially fraudulent. In FIG. 7, the system 710 flags transaction 770 as potentially fraudulent. Any flagged transactions may be reported to the user. Specifically, the system 710 can send alerts directly to the user by way of the mobile application that runs on the user's mobile device 720. The alerts can include a text message, email, telephone call, or other means of communication. In some embodiments, the transaction amount, timestamp, and merchant information are conveyed with the alert to the user. Upon receiving an alert, the user can validate the flagged transaction or take corrective action to avoid future fraud if the user did not engage in the transaction.

In some embodiments, the alert includes a link with which the user can invoke remedial action. Invocation of the link can cause the system back-end to generate a fraud claim with the transaction processor on behalf of the user. Specifically, the system back-end notifies the transaction processor that a particular transaction executed by a merchant was not authorized or performed by the user and is therefore fraudulent. The transaction processor can then refund the user the transaction charges, close the user account to prevent further fraud, and investigate the fraud. In some embodiments, invoking the link to the remedial action causes the system back-end to temporarily suspend the user's charge account so that no further transactions are completed while the potential fraud is investigated.

FIG. 7 is effective in identifying identity theft that occurs at a merchant physical location. However, commerce has gradually shifted online and more transactions are completed at virtual storefronts rather than physical storefronts. Sites like Amazon.com and Ebay.com bring buyers and sellers together without the buyers having to visit a seller's physical storefront or physical location and without the sellers having to provide a physical storefront. In other words, buyers can complete transactions from home or any location where they have network connectivity and sellers can similarly complete transactions from home or a warehouse without any physical contact with the buyer. Therefore, detecting identity theft in online transactions requires a different approach.

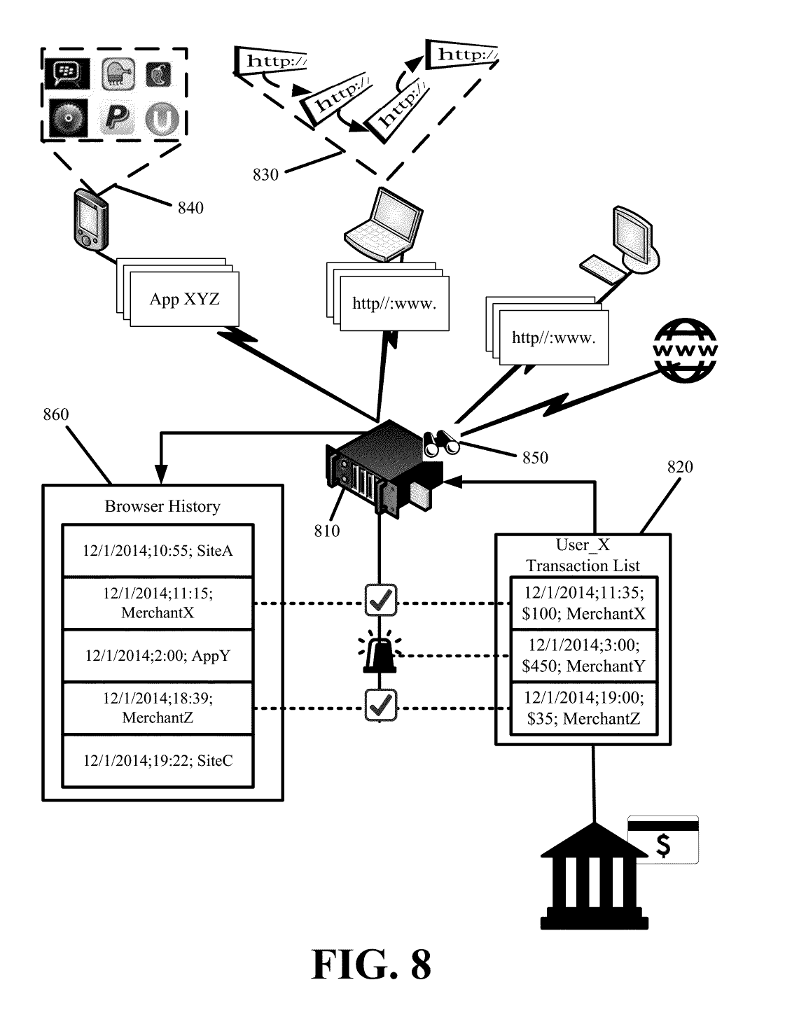

FIG. 8 conceptually illustrates detecting identity theft that occurs in online transactions in accordance with some embodiments. As with the previous approach, the system 810 obtains a list of transactions 820 that have been charged to one or more user accounts from a transaction aggregator or transaction processor. The transaction list 820 again includes at least one identifier and a timestamp. The identifier identifies a merchant that completed each transaction. In some embodiments, the system 810 maps the transaction identifier to a domain name or merchant name. The timestamp identifies the date and time when each transaction was completed.

Since online transactions can be completed anywhere, the system 810 monitors user online activity rather than user location. The system 810 monitors user online activity in a variety of ways.

At 830, the system 810 monitors user online activity by accessing the user's browser history from one or more user registered devices. From the browser history, the system 810 obtains lists of visited domain names and a timestamp associated with each domain name visit. In some embodiments, the system 810 maps visited domain names to merchant names.

At 840, the system 810 monitors user online activity by monitoring the user device logs. In this case, the system 810 monitors when processes or applications are launched or execute. Merchant names can be deduced from the process or application name within the log. For example, when the user device launches the eBay mobile application, the system associates that application's instantiation as a visit to the eBay merchant.

At 850, the system 810 monitors user online activity by configuring itself as an initial gateway or proxy for communications sent from the user device. In some such embodiments, the system 810 receives and monitors all outgoing requests from the user device in a non-intrusive and pass-through manner. The system 810 forwards the requests to the appropriate destination such that there is little to no impact on the user experience while also tracking the domain to which the request was directed as well as a timestamp for when the request was issued.

In each case, the user installs a system 810 provided application on its network connected devices. The installed application accesses the browser history, accesses the running process or application logs, or makes changes to the user device configuration in order to monitor the online activity using any of the aforementioned methods. The application sends the monitored online activity back to the system 810. For example, the particular user may use a laptop computer while at work, a smartphone while on the go, and a tablet while at home. The system application is installed on each of three devices. The three installed applications then report any monitored online activity from the corresponding user device to the system 810. The system 810 aggregates all of a particular user's online activity from the applications running on the particular user's different devices to a browser history database 860.

The system 810 performs a mapping operation to convert the tracked domain names, application names, process names, etc. to a merchant name. The system 810 then attempts to match the user's online activity to the online sites or merchants where each transaction from an obtained transaction list took place. The system 810 does so by obtaining a timestamp of a transaction and a merchant that conducted the transaction. The system then scans the compiled user online activity to determine if the user visited one of the merchant's online sites or services at or near the transaction timestamp. Here again, if a match is found, the system verifies the transaction as being valid. If a match cannot be found, the system flags the transaction as potentially fraudulent and presents any such flagged transactions to the user for validation. This approach can be combined with the user location tracking approach of FIGS. 7 to verify all user transactions irrespective of whether they occur at a merchant storefront or online.

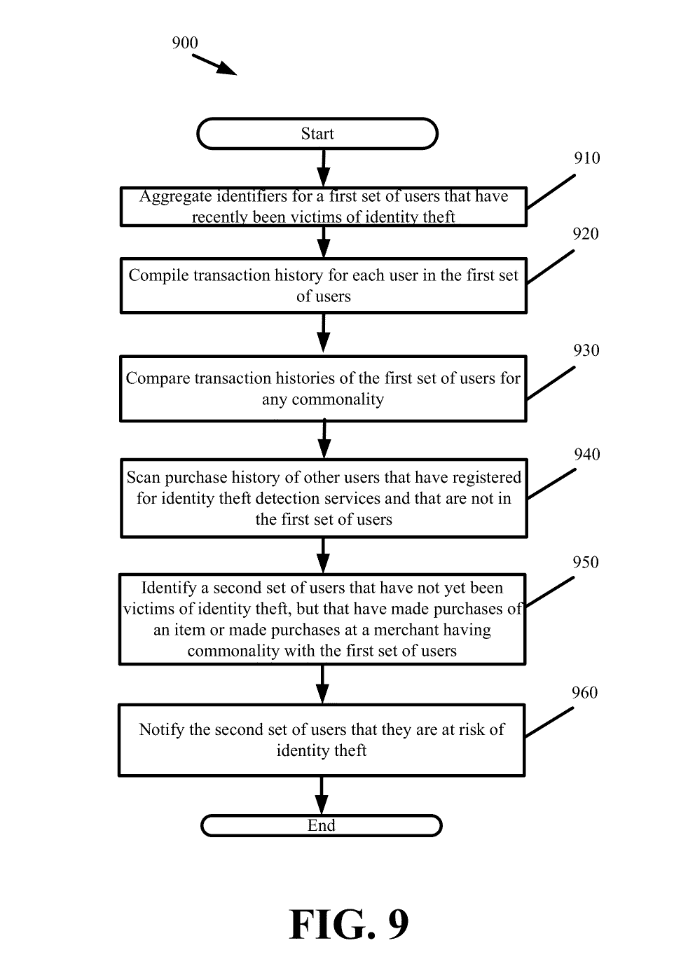

FIG. 9 presents a process 900 providing a crowd-sourced approach to the detection and prevention of identity theft in accordance with some embodiments. Process 900 is performed using the front-end application and system back-end machines of some embodiments.

The process commences with the system back-end aggregating (at 910) identifiers for a first set of users that have recently been victims of identity theft. More specifically, the process aggregates identifiers for users that have been victimized with unauthorized transactions to one or more of their accounts.

Next, the process compiles (at 920) a transaction history for each user in the first set of users. Of most relevance, the process compiles transactions that occurred prior to the unauthorized transaction associated with the instance of identity fraud. In some embodiments, the system back-end communicably couples with and aggregates the transactions from one or more transaction processors based on partnerships established with the transaction processors or using authorization provided by the users.

The process cross compares (at 930) the transaction histories in order to identify any commonality. The cross comparison reveals whether the first set of users have purchased any of the same items or whether the first set of users purchased items from a common merchant. Any such commonality shared between the first set of users can be indicative of where the identity theft originated. In other words, the commonality can reveal the source from where confidential user information was misappropriated. In some embodiments, the system back-end discovers commonality when the same item or common merchant is identified in a threshold number of the transaction histories.

The process then scans (at 940) purchase history of other users that have registered for identity theft detection services from the system and that are not in the first set of users. Specifically, the process scan the user purchase histories in order to identify (at 950) a second set of users that have not yet been victims of identity theft, but that have made purchases of the common item or made purchases at the common merchant where the identity theft is believed to have originated. The process notifies (at 960) the second set of users that they are at risk of identity theft. The process can further identify preventative action that the second set of users can take to mitigate the risk. The actions can include changing passwords or canceling the charge cards that are issue. The notification step can involve the system back-end sending an alert over the Internet to a front-end application running on each device of the second set of users. The alert activates the front-end application on the user device and causes the application to present the identity theft risk including identification of the potentially compromised merchant and the preventative actions for mitigating the risk.

The crowd-sourced approach can be modified to identify an online source where identity theft originates. In some embodiments, the system looks to the browser history or process or application instantiation history of a set of victimized users for commonality. Common sites or applications amongst the set of victimized users can then be identified as a potential source where identity theft originates. The system can then notify other users that have visited the same sites or launched the same applications that they too may be at risk.

V. Theft Prevention

The above embodiments protect a user's identity from the user's own actions. However, the user's identity can become compromised as a result of actions by others. For instance, data breaches and successful hacks of merchant sites, banks, and other institutions storing confidential information about the user can open the user to identity theft despite the user's best efforts.

The misappropriated confidential user information can be used by others to fraudulently obtain benefits including funds, goods, and services in the user's name without the user's knowledge. Government fraud and insurance fraud are some examples of benefits fraud where identity theft is used for illegal gain. In such cases, a fraudster files tax returns or benefit claims in the name of a particular user, but redirects the funds or benefits to accounts or addresses of the fraudster' s own choosing rather than accounts or addresses belonging to the particular user. Loan fraud and other fraud can be perpetrated in a similar manner.

Some embodiments provide identity theft prevention solutions that target and prevent the misuse of misappropriated confidential information. The solutions revolve around user verification.

Users register for the identify theft prevention solutions. Registration involves a multi-step verification of the user identity and receipt of verified user information once the user's identity has been verified. The multi-step verification ensures that the verified user information is not coming from a falsified source. The verification may involve obtaining and validating identifying documentation from the user including previously filed tax returns and government issued identification (e.g., passports, driver's license, birth certificates, etc.) as some examples. Once the user's identity is verified, the system collects verified information from the user including, for example, the user's social security number, employer identification number, street addresses, email addresses, telephone numbers, bank or deposit account numbers, or other identifying information that may be misappropriated for procurement of benefits including funds, goods, and services in the user's name. The verified information is entered through a secure system interface that is accessible over a network using a device with network connectivity. The verified information is securely stored within a system database as part of a user profile or account.

The system partners with governmental agencies and merchants that require a means to verify the identity of users receiving funds, benefits, goods, and services. The system exposes the verified user information to its partners through a remote interface or application programming interface. The verified user information ensures that the user receiving the benefits (e.g., funds, goods, and services) is the user that is entitled to the benefits, is the user for which the claim of benefits is submitted, or is the user identified as making the purchase or request for the benefits.

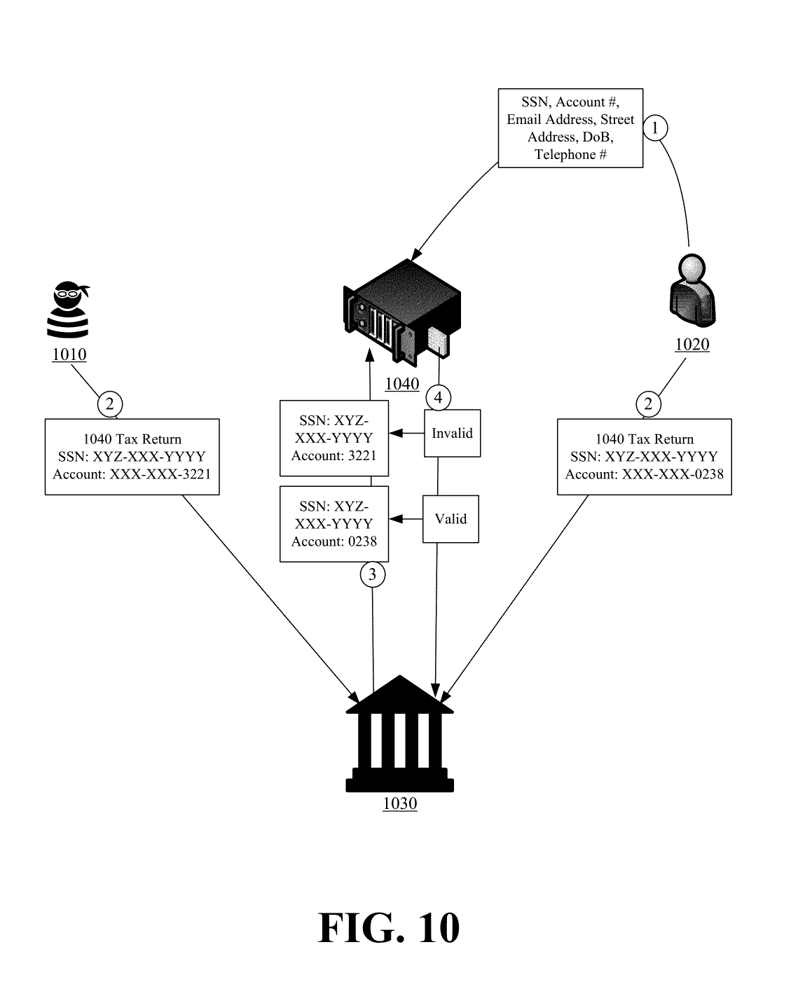

FIG. 10 illustrates preventing identity theft by preventing the misuse of misappropriated information in accordance with some embodiments. The figure illustrates two different entities 1010 and 1020 filing a claim for benefits with governmental agency 1030. As one example, the governmental agency 1030 can be the Internal Revenue Service (IRS) and the claim for benefits can be tax returns in which a refund is due to the filer. Continuing with this example, the entities 1010 and 1020 file tax returns using the social security number of the same individual. Accordingly, at least one of the tax returns is falsified.

The governmental agency 1030 uses the theft prevention services provided by the system 1040 of some embodiments to verify the claims are valid. The governmental agency 1030 submits the benefit recipient information provided by each entity to the user verification service provided by the system 1040 of some embodiments. Specifically, the governmental agency 1030 forwards the social security number and the last four digits for the benefit deposit checking account identified by each entity 1010 and 1020. Generally, the party requesting verification needs to submit to the system a first identifier identifying the user to be verified and a second identifier identifying how the user is to receive the requested benefits. The information can be forwarded over a secure network connection. Based on the forwarded information, the system 1040 verifies that the claim filer and benefit recipient are the same entity.

The individual identified by the social security number is registered with the system 1040 for the theft prevention service. Accordingly, as part of the verified information provided by the individual when registering with the system 1040, the individual provides his social security number and the last four digits of his checking account. Using this verified information, the system 1040 identifies that the first entity's 1010 benefit claim specifies an unverified deposit account for the individual's social security number, and the second entity's 1020 benefit claim specifies the verified deposit account for the individual's social security number. The system 1040 notifies the governmental agency 1030 of the verified status of the second entity 1020 and the unverified status of the first entity 1010, thereby authorizing the fund disbursement from the governmental agency 1030 to the second entity 1020. The system 1040 can also send an alert over the Internet to a front-end application running on a device of the second entity 1020 to notify the second entity 1020 of the attempted fraud by the first entity 1010.

The governmental agency 1030 is then able to prevent the misuse of the individual's social security number and prevent the fraud from occurring by denying the benefit claim made by the first entity 1010 or by requiring the first entity 1010 to provide additional information to verify its true identity. The government agency 1030 also forwards the fund disbursement to the second entity 1020 in response to the system 1040 provided authorization ensuring that the claim is not fraudulently filed.

In some embodiments, the system 1040 controls the disbursements of funds and benefits on behalf of the governmental agency 1030. In some such embodiments, the governmental agency 1030 processes user submitted claims as normal. However, any disbursements are first sent to the system 1040 of some embodiments. The system 1040 then verifies the user receiving the benefits. If fraud is detected, the system 1040 denies the transfer and returns the benefits to the governmental agency 1030. If no fraud is detected, the system 1040 forwards the benefits to the user. The system 1040 may forward the benefits as an electronic funds transfer (EFT) or other electronic payment sent to a deposit account or email address of the user. The system 1040 may also forwards the benefits through the mail to an address of the user.

The theft prevention service of some embodiments can similarly be used to prevent theft of social security benefits, medical benefits, and other governmental and insurance fund disbursements. The theft detection service can also be extended to prevent fraudulent online purchases wherein goods and services purchased using a stolen credit card number are being shipped to an unverified address.

In some embodiments, users pay a fee to register for the theft prevention service with the service being freely available to the governmental agencies, merchants, and other entities that need to verify user identity prior to disbursement of benefits to the entity. In some other embodiments, the governmental agencies, merchants, and other entities needing the user verification services pay a fee to partner with the system and gain access to the verified information, while users can freely register with the system and provide the verified information to protect themselves against identity theft.

Some embodiments provide different benefit distribution verification services. In some such embodiments, the system back-end provides a front-end application to be installed on a mobile network enabled device of a user, such as a smartphone or tablet. The user registers with the system back-end using the front-end application. Here again, as part of registration, the user submits official documentation and other information that the system back-end can use to verify the user's identity. From the registration, the system back-end obtains identifiers identifying the user including the user's social security number or name as some examples. By virtue of the front-end application being installed on the user device, the system back-end has a direct method of contacting the user. The direct method can then be used to alert the user of a benefit distribution and the user can accept or reject the distribution using the front-end application. In some embodiments, the front-end application obtains and sends the system back-end the telephone number, international mobile subscriber identity (IMSI), or Internet Protocol address of the user's device. In some other embodiments, the front-end application sends the system back-end a URL or link that the system back-end can subsequently use to communicate with the front-end application. In any case, the system back-end associates a verified user to a particular instance of the front-end application.

In some embodiments, the system back-end receives a request to verify a benefit claim on behalf of a benefit distributor. The request includes a first identifier identifying an entity intended to receive the benefit and a second identifier identifying a destination where the benefit distributor is to send the benefit. From the first identifier, the system back-end identifies a verified user and forwards the benefit request along with the destination as an alert over the Internet to the verified user's device. The alert activates the front-end application on the user device to cause the device to display the benefit to be distributed and the destination where it is to be sent. The alert further includes a first link with which the verified user can accept the distribution and a second link with which the verified user can reject the distribution should the destination be a fraudulent one or one that the verified user does not recognize. In response to the verified user accepting the benefit distribution, the front-end application signals the system back-end which causes the system back-end to initiate transfer of the benefit from the benefit distributor to the identified destination. In other words, the system back-end authorizes the benefit distributor to send the benefit. In some other embodiments, the system back-end initiates an electronic funds transfer or wire transfer of the benefit to the verified user in response to the verified user accepting the benefit distribution. In response to the verified user rejecting the benefit distribution, the system back-end notifies the benefit distribution of the fraud or error, thereby preventing the transfer of the benefit to the identified destination.

VI. Computer System

Many of the above-described systems, processes and components are implemented as software processes that are specified as a set of instructions recorded on a non-transitory computer-readable storage medium. When these instructions are executed by one or more computational element(s) (such as processors or other computational elements like ASICs and FPGAs), they cause the computational element(s) to perform the actions indicated in the instructions, thereby transforming a general purpose computer to a specialized machine implementing the methodologies and systems described above. Computer and computer system are meant in their broadest sense, and can include any electronic device with a processor including cellular telephones, smartphones, portable digital assistants, tablet devices, laptops, desktops, and servers. Examples of computer-readable media include, but are not limited to, CD-ROMs, flash drives, RAM chips, hard drives, EPROMs, etc.

FIG. 11 illustrates a computer system with which some embodiments are implemented. Such a computer system includes various types of computer-readable mediums and interfaces for various other types of computer-readable mediums that implement the various processes, modules, and systems described above. Computer system 1100 includes a bus 1105, a processor 1110, a system memory 1115, a read-only memory 1120, a permanent storage device 1125, input devices 1130, and output devices 1135.

The bus 1105 collectively represents all system, peripheral, and chipset buses that communicatively connect the numerous internal devices of the computer system 1100. For instance, the bus 1105 communicatively connects the processor 1110 with the read-only memory 1120, the system memory 1115, and the permanent storage device 1125. From these various memory units, the processor 1110 retrieves instructions to execute and data to process in order to execute the processes of the invention. The processor 1110 is a processing device such as a central processing unit, integrated circuit, graphical processing unit, etc.

The read-only-memory (ROM) 1120 stores static data and instructions that are needed by the processor 1110 and other modules of the computer system. The permanent storage device 1125, on the other hand, is a read-and-write memory device. This device is a non-volatile memory unit that stores instructions and data even when the computer system 1100 is off. Some embodiments of the invention use a mass-storage device (such as a magnetic or optical disk and its corresponding disk drive) as the permanent storage device 1125.

Other embodiments use a removable storage device (such as a flash drive) as the permanent storage device Like the permanent storage device 1125, the system memory 1115 is a read-and-write memory device. However, unlike the storage device 1125, the system memory is a volatile read-and-write memory, such as random access memory (RAM). The system memory stores some of the instructions and data that the processor needs at runtime. In some embodiments, the processes are stored in the system memory 1115, the permanent storage device 1125, and/or the read-only memory 1120.

The bus 1105 also connects to the input and output devices 1130 and 1135. The input devices enable the user to communicate information and select commands to the computer system. The input devices 1130 include any of a capacitive touchscreen, resistive touchscreen, any other touchscreen technology, a trackpad that is part of the computing system 1100 or attached as a peripheral, a set of touch sensitive buttons or touch sensitive keys that are used to provide inputs to the computing system 1100, or any other touch sensing hardware that detects multiple touches and that is coupled to the computing system 1100 or is attached as a peripheral. The input devices 1130 also include alphanumeric keypads (including physical keyboards and touchscreen keyboards), pointing devices. The input devices 1130 also include audio input devices (e.g., microphones, MIDI musical instruments, etc.). The output devices 1135 display images generated by the computer system. The output devices include printers and display devices, such as cathode ray tubes (CRT) or liquid crystal displays (LCD).

Finally, as shown in FIG. 11, bus 1105 also couples computer 1100 to a network 1165 through a network adapter (not shown). In this manner, the computer can be a part of a network of computers such as a local area network (“LAN”), a wide area network (“WAN”), or an Intranet, or a network of networks, such as the internet. For example, the computer 1100 may be coupled to a web server (network 1165) so that a web browser executing on the computer 1100 can interact with the web server as a user interacts with a GUI that operates in the web browser.

As mentioned above, the computer system 1100 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, and any other optical or magnetic media.

While the invention has been described with reference to numerous specific details, one of ordinary skill in the art will recognize that the invention can be embodied in other specific forms without departing from the spirit of the invention.

We claim:

1. A method of identity protection, the method comprising:
providing an identity protection front-end application to a particular user for installation on a network enabled device of the particular user;
receiving a plurality of posts linked to an account of the particular user from an online site at an identity protection back-end machine over the Internet, the back-end machine comprising a microprocessor and a memory that stores a set of protected categories, wherein the microprocessor
extracts at least one particular post from the plurality of posts comprising a disclosure violating a particular protected category from the set of protected categories;
generates an identity protection alert comprising the particular post, potential harm from the particular host, and a remediation step comprising a link for resolving violation of the particular category from the particular post; and
transmits the identity protection alert over a network connection to the particular user device, wherein the alert activates the front-end application to cause the identity protection alert to display on the particular user device and to further cause the back-end machine to connect to the online site over the Internet and modify the particular post in response to the particular user invoking the remediation step link within said alert.

2. The method of claim 1, wherein the particular category protects against disclosures of confidential information used for password recovery, and wherein the back-end machine microprocessor modifies the particular post by removing at least one word revealing confidential information about the particular user from the particular post linked to the particular user account at the online site.

3. The method of claim 1, wherein the particular category protects against disclosures of confidential information used for password recovery, and wherein the back-end machine microprocessor modifies the particular post by removing an image revealing confidential information about the particular user from the particular post linked to the particular user account at the online site.

4. The method of claim 1, wherein the particular category protects against travel disclosures, and wherein the back-end machine microprocessor modifies the particular post by removing travel related information from the particular post linked to the particular user account at the online site.

5. The method of claim 1, wherein the particular category protects against disclosures damaging the particular user reputation, and wherein the back-end machine microprocessor modifies the particular post by performing one of correcting spellings and grammatical errors in the particular post and removing prejudicing statements from the particular post.

6. A method of identity protection, the method comprising:
providing an identity protection front-end application to a particular user for installation on a network enabled device of the particular user;
receiving a plurality of posts linked to an account of the particular user and publicly accessible from an online site at an identity protection back-end machine over the Internet, the back-end machine comprising a microprocessor and a memory, wherein the microprocessor
identify a current privacy setting for said account from the plurality of posts;
select an optimal privacy setting from a plurality of available privacy settings available at the online site based on a number, frequency, and content of the plurality of posts, wherein the optimal privacy setting is different than the current privacy setting;
generate an identity protection alert comprising the optimal privacy settings for the particular user account and a remediation step; and
transmits the identity protection alert over a network connection to the particular user device, wherein the alert activates the front-end application to cause the identity protection alert to display on the particular user device and to further cause the back-end machine to connect to the online site over the Internet and adjust the account privacy settings from the current privacy settings to the optimal privacy settings when the particular user invokes the remediation step.

7. The method of claim 6, wherein adjusting the account privacy settings restricts public access to a subset of the plurality of posts linked the particular user account at the online site.

8. The method of claim 6 further comprising receiving a plurality of contacts linked to the particular user account.

9. The method of claim 8, wherein said receiving comprises requesting the particular user add an identity protection account as a contact of the particular user account to enable access to the plurality of contacts that are linked to the particular user account.

10. The method of claim 8, wherein the back-end machine microprocessor further verifies a first contact from the plurality of contacts is an attack risk, and wherein said alert identifies the first contact as an attack risk.

11. The method of claim 10, wherein the back-end machine microprocessor verifies the first contact is an attack risk when an account of the first contact is not linked to at least one common contact also in the plurality of contacts, and wherein the back-end machine microprocessor verifies a second contact of the plurality of contacts is not an attack risk when an account of the second contact is linked to at least one common contact also in the plurality of contacts.

12. The method of claim 10, wherein the back-end machine microprocessor verifies the first contact is an attack risk when a threshold amount of valid activity is not posted to an account of the first contact, and wherein the back-end machine microprocessor verifies a second contact of the plurality of contacts is not an attack risk when a threshold amount of valid activity is posted to an account of the second contact.

13. The method of claim 10, wherein the back-end machine microprocessor verifies the first contact is an attack risk when first contact identifying information from an account of the first contact at the online site does not match first contact identifying information obtained from an external data source.

14. The method of claim 10, wherein the back-end machine microprocessor verifies the first contact is an attack risk by analyzing posts published by the first contact to the online site and identifying at least one post comprising an attack or a link to an attack.

15. A method of identity protection, the method comprising:
providing an identity protection front-end application to a particular user for installation on a network enabled device of the particular user;
connecting to each of a plurality of sites where the particular user is registered with an account;
receiving at an identity protection back-end machine over the Internet, a plurality of publicly accessible posts linked to each particular user account at each site of the plurality of sites, the back-end machine comprising a microprocessor and a memory, wherein the microprocessor
initiates an account recovery operation for the particular user account at a particular site of the plurality of sites;
sending responses to questions of the account recovery operation using information from the plurality of publicly accessible posts;
generates an identity protection alert identifying the particular user account and a subset of the plurality of publicly accessible posts containing information correctly answering the account recovery operation questions; and
transmits the identity protection alert over a network connection to the particular user device, wherein the alert activates the front-end application to cause the identity protection alert to display on the particular user device.

16. The method of claim 15, wherein the alert comprises a remediation step with a link for securing access to the particular user account, and wherein the alert further causes the back-end machine to modify the subset of publicly accessible posts to remove the information correctly answering the account recovery operation questions in response to the particular user invoking the remediation step link.

17. The method of claim 15, wherein the back-end machine further generates a list of passwords based on information extracted from the plurality of publicly accessible posts, wherein the alert comprises the list of passwords and a remediation step with a link for securing access to the particular user account.

18. The method of claim 17, wherein the alert further causes the back-end machine to connect to the particular user account at the particular site over the Internet and change the password for accessing the particular user account in response to the particular user invoking the remediation step link.

19. The method of claim 15, wherein the back-end machine further derives a confidential information inquiry from the plurality of publicly accessible posts and transmits the confidential information inquiry over the Internet to a contact linked to the particular user account in an attempt to extract additional confidential information about the particular user from the contact.
